(19) United States
(12) Patent Application Publication
(10) Pub. No.: US 2007/0110408 A1
(43) Pub. Date: May 17, 2007

(54) DEVICE FOR DISPLAYING BOOT ANIMATION OF OPTICAL DISC PLAYER AND METHOD THEREOF

(76) Inventors: Chi-Lun Chang, Hsinchu City (TW); Yu-Hau Chen, Hsin-Chu Hsien (TW); Kai-Hong Yang, Shenzhen, Guangdong (CN)

Correspondence Address: NORTH AMERICA INTELLECTUAL PROPERTY CORPORATION, P.O. BOX 506, MERRIFIELD, VA, 22116, US

(21) Appl. No.: 11/459,006

(22) Filed: Jul. 20, 2006

Related U.S. Application Data
(60) Provisional application No. 60/597,146, filed on Nov. 14, 2005.

(51) Int. Cl. H04N 5/00

(52) U.S. Cl. 386/126

(57) ABSTRACT

A method for displaying a boot animation of an optical disc player during a boot-up sequence of the optical disc player is disclosed. The method includes reading a boot animation data stream stored in the optical disc player storage device and processing the boot animation data stream for displaying the boot animation.

### CROSS REFERENCE TO RELATED APPLICATIONS

This application claims the benefit of U.S. Provisional Application No. 60/597,146, which was filed on Nov. 14, 2005 and is included herein by reference.

### BACKGROUND

The present invention relates generally to a device for displaying a boot animation and related method, and more particularly, to a device for displaying a boot animation for an optical disc player and the related method.

Optical disc players include consumer electronic devices such as but not limited to: VCD players, DVD players, and all combinations of DVD/VCD/DVD-R/RW. In general, this group of consumer electronic devices is commonly referred to as optical disc players. Optical disc players were relegated to a small fraction of the related consumer market due to the popularity of video tape players. In recent years, however, optical disc players have enjoyed almost complete dominance in this market.

Optical disc players offer many advantages over their video tape predecessors. The advantages are many and well-known. But, in particular, optical disc players access media in a random access method while video tape players access media in a sequential method. Random access to the data on the media used by the optical disc player allows the optical disc player to quickly access areas of the disc that contain various different data. For example, data can be considered to be a movie or other similar recorded video and audio performance. The operation of the optical disc's random access method and the associated advantages it can offer versus the sequential access method of the video tape player and its associated limitations are well-known to a person of average skill in the pertinent art, therefore, additional details are omitted for the sake of brevity.

Unfortunately, certain aspects of the optical disc player do not utilize this advantage. Therefore, the users of the optical disc players experience a less than fully exploited technology experience. In particular, after the user turns on the optical disc player there is a period of time when the user must wait. For example, during this time the optical disc player may be recognizing the inserted disc and accessing the disc's menu that will soon be displayed on a screen or other similar output device like a television or LCD display. The dead time after the optical disc player is turned on but before the disc's menu is displayed, is a particularly boring moment for the user. This is certainly a hold over from the days of video tape players. Due to the limitations of the video tape player's sequential access, it is not possible to offer users menus, or any other interactive or non-sequential experience. Therefore, this dead period of time was the best that could be offered to the user.

New ideas and devices as obviously needed and the new ideas and devices need not be limited by the restrictive thinking that was imposed by older technology like video tape players. Yet, the optical disc player continues to offer nothing more than a boring and unimpressive boot sequence. At best, the boot sequence of a state of the art optical disc player might include a single still image display.

Additionally, the optical disc player's capability to perform random access of media has not been fully utilized in other ways. Today's optical disc players, at best, offer a still image during the boot sequence and the still image is preset during the time of manufacturing. In other words, optical disc players offer a static boot sequence. In this case, static means a number of things, including but not limited to: still images, unchangeable images, no image (i.e., a blank screen), and no versatility.

Therefore, it is apparent that new and improved methods and devices are needed to solve the aforementioned problems.

### SUMMARY

It is therefore one of the primary objectives of the claimed invention to provide a method for displaying a boot animation and the related device thereof, to solve the aforementioned problems.

According to an embodiment of the claimed invention, a method for displaying a boot animation during a boot-up sequence of the optical disc player is disclosed. The method includes reading a boot animation data stream stored in the optical disc player storage device and processing the boot animation data stream for displaying the boot animation.

The claimed invention additionally reveals another method of adding or updating a boot animation data stream to an optical disc player, a boot animation associated with the boot animation data stream being displayed during a boot-up sequence of the optical disc player. The method includes receiving a source audio/video stream; and storing the video stream and the audio stream separately. The boot animation data stream includes the video stream and the audio stream.

In addition, an optical disc player for displaying a boot animation on a display device during a boot-up sequence is disclosed. The optical disc player has a processor; and a storage device, coupled to the processor, for storing a program execution code. The program execution code executed by the processor is utilized for reading a boot animation data stream stored in the storage device and processing the boot animation data stream for controlling the hardware decoder and display device to display the boot animation.

Further, the claimed invention provides an optical disc player for adding or updating a boot animation data stream to an optical disc player. A boot animation is associated with the boot animation data stream being displayed during a boot-up sequence of the optical disc player. The optical disc player includes a processor; and a storage device, coupled to the processor, for storing a program execution code. The program execution code executed by the processor is utilized for receiving a source audio/video data stream; demultiplexing the audio/video data stream to generate a video stream and an audio stream; and storing the video stream and the audio stream separately in the storage device; wherein the boot animation data stream includes the video stream and the audio stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an optical disc player according to an embodiment of the present invention.

FIG. 2 is a flow chart showing a method for a boot sequence of an optical disc player according to an embodiment of the present invention.

FIG. 3 is a flow chart showing a method for adding or updating a boot sequence of an optical disc player according to an embodiment of the present invention.

FIG. 4 is a block diagram showing the data portions of the boot animation area.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

In contrast to the related art, the present invention optical disc player provides an exciting and dynamic boot sequence. In particular, the present invention displays a video, plays an audio, or both, after the time that the user has turned on the optical disc player but before the optical disc player displays a menu associated with the inserted media (i.e., compact disc, DVD disc, VCD disc). In other words, during the time between turning on the optical disc player and when a disc's menu is displayed, the present invention displays video, or plays audio, or both in what would be an otherwise static and unimpressive period of dead time. The video can be but is not limited to an MPEG 4 stream. The audio can be but is not limited to an MP3 stream. Obviously, the present invention can support any video and audio formats including those existing today and those yet to be developed.

The primary purpose of the boot animation is to provide the optical player system more versatile power on effect. In some embodiments, the disc recognizing will be started after boot animation finishes and in this way there is some time savings that are not utilized. In another embodiment, additional time savings can be realized by doing the disc recognizing at the same time of boot animation to save the time of disc recognizing.

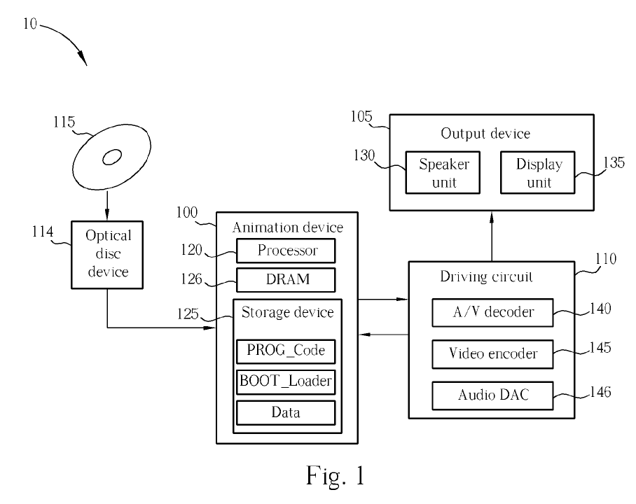

To explain the present invention optical disc player, please refer to FIG. 1. FIG. 1 is a simplified block diagram of an optical disc player 10 according to an embodiment of the present invention. An optical disc player 10 includes an animation device 100. The animation device 100 further comprises a processor 120, a storage device 125, and a DRAM 126. The storage device 125 can be, for example, a Flash memory, however, the present invention is not limited to implementation via the Flash memory. The storage device 125 is coupled to the processor 120. The storage device 125 is utilized for storing a program execution code PROG_CODE and boot animation data stream. Please note that the program execution code PROG_CODE executed by the processor 120 is used for reading a boot animation data stream stored in the storage device 125 and processing the boot animation data stream for controlling the output device 105 to display the boot animation. Please note that the DRAM 126 is offered by way of example and not limitation. For example, Flash RAM and other similar memory storage devices can as easily operate as the DRAM 126 while maintaining the spirit of the present disclosure. The PROG_Code and BOOT_Loader and Data stored in the storage device 125 (e.g., Flash memory) can, for example, be compressed, and then said stored data can be transferred to the DRAM 126 for decompression, in this case, faster execution and faster access as needed. This is not a limitation of the present invention. A program execution boot loader code BOOT_LOADER is also executed by the processor 120 and is utilized for reading a first frame of the boot animation data stream DATA that is stored in the storage device 125. The program execution boot loader code BOOT_LOADER, executed by the processor 120, further processes a first frame of the animation data stream DATA for displaying a corresponding image, for example, on the output device 105, during an execution of a boot loader of the optical disc player 10. In addition to processing a first frame of the animation data stream DATA, the program execution boot loader code BOOT_LOADER can handle the boot sequence of the optical disc player 10, for example, loads the program execution code PROG_CODE into a volatile memory for execution. The operational details and configuration details related to running the boot loader to complete the boot sequence are all well-known to those of average skill in this art, therefore, further explanation of these details and their operations are omitted herein for the sake of brevity.

It should be noted that due to the limited code size of BOOT_LOADER, program execution boot loader code BOOT_LOADER, in another embodiment, reads the first frame of the animation data stream DATA and then passes the first frame to A/V decoder 140 for hardware decoding only. In other words, the playback of the first frame will not affect the execution of a normal boot sequence since the first frame is processed by hardware only. In addition, compared with the related art boot loader, the size of the program execution boot loader code BOOT_LOADER of the present invention is not significantly increased.

The boot animation data stream DATA stored in the storage device 125 can be encoded in many formats, including but not limited to: format types VCD-1, MPEG-2, DIVX, MPEG-4, AC3, DTS, or MP3. The present invention does not limit the boot animation data stream DATA to be encoded by only these formats. It is obvious to one of average skill in this art that the format is not important to the spirit of the present invention nor does the format particularly affect the spirit of the functionality of the present invention.

Coupled to the animation device 100 is a disc reader 114 for reading an optical disc 115. In this way the animation device 100 receives a source audio/video data stream read from the optical disc 115 if this optical disc is the pre-defined boot animation update disc, wherein the source audio/video stream from the optical disc 115 to the animation device 100 can be updated to storage device and then be read and decoded for boot animation display. Specifically, the program execution code PROG_CODE executed by the processor 120 receives the source audio/video stream in the pre-defined boot animation update disc and stores the video stream and the audio stream separately in the storage device 125. Details of these operations are well-known to those of average skill in this art and are unimportant to the operation and spirit of the present invention. Please note that the present invention executes audio/video demultiplex by a PC utility when the boot animation file in the special boot animation update disc is generated. This is done for purposes of efficiency to keep from overtaxing the processing power of the processor 120 later when the present invention is used in a mode for playing the boot animation.

Regarding the PC utility, please note that in an embodiment of the present invention, the PC utility can be running in an MS Windows environment to generate the boot animation data stream. Therefore, in this embodiment, the demultiplex is not performed by the processor of the optical player, or by the animation device 100, rather this processor task is executed by the PC utility in advance (i.e., anytime prior to the execution of the present invention animation device 100). Therefore, the present invention, in this embodiment, does not need to add the related code of demultiplex into the processor execution code. The format also can specify the audio and video stream location and no more demultiplex process is needed be done by optical player system processor of said system.

Please note, the boot animation adding, or updating method is not restricted to reading from an optical disc, for example, a boot animation update disc. The present invention can set a playback clip in the regular playback disc as a new, added, or updated boot animation. Because the video and audio demultiplex are already performed during playback, the present invention simply stores the video and audio stream and then adds or updates the said stream to the storage device 125 during the time when the optical player system plays said clip.

Coupled to the animation device 100 is a driving circuit 110. The driving circuit 110 is implemented by hardware and used for decoding the audio/video encoded stream that the driving circuit 110 received from the animation device 110. Please note if the processor 120 is provided with sufficient computing power, the functionality of the driving circuit 110, in another embodiment, could be implemented by software. The driving circuit 110 generates a video decoded (raw) stream and an audio decoded (raw) stream from the given audio/video encoded stream. This is accomplished using the A/V decoder 140 that is disposed within the driving circuit 110. Additionally, the driving circuit 110 includes a TV encoder 145 and an audio DAC 146 that are used for encoding the video to TV signal format streams and analog audio streams, respectively, to prepare the audio and video streams for sending to the output device 105. Please note, the driving circuit 110 can make significant use of the DRAM 126 as needed by the requirements at hand.

It is advantageous for the present invention to store the video and audio stream as a separate video stream and audio stream to ensure that the processor 120 is capable of driving the driving circuit 110 sufficiently fast to provide the output device 105 with the A/V stream (i.e., the audio stream and the video stream) without incurring delays that may otherwise occur if the stream were demultiplexed during the operation of the boot sequence of the optical disc player 10.

Furthermore, the program execution code PROG_CODE must verify if the optical disc 115 has a specified disc volume, and a boot animation update file with the same boot animation format in the storage device stored in specified path and having specified file name. This is necessary for the present invention when used in a mode for adding or updating boot animation to the optical disc player 10 to determine if the optical disc 115 is a regular disc used for viewing movies and other pre-recorded material or if the optical disc 115 has been specifically formatted and configured to be a special boot animation disc that can be used for adding or updating the boot animation sequence to the optical disc player 10. To know that the optical disc 115 is a disc holding boot animation that is intended for adding or updating to the optical disc player 10, the program execution code PROG_CODE will read the boot animation update file to be the video stream and the audio stream respectively when the optical disc 115 has a specified disc volume and a boot animation update file that are stored in specified path and having specified file name.

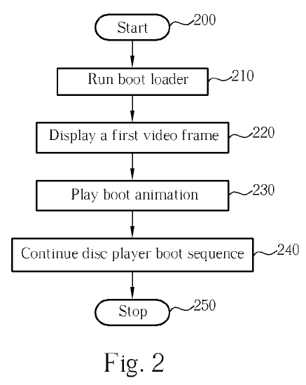

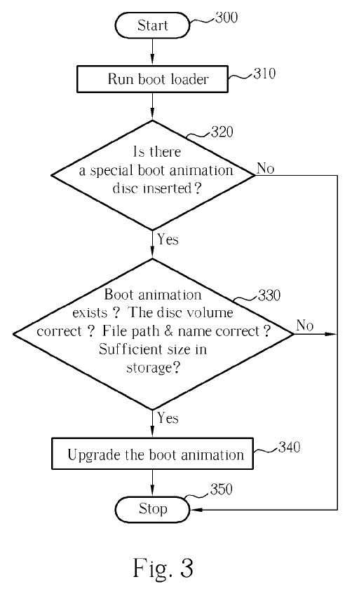

During the operation of accessing and storing the boot animation, it is necessary for the program execution code PROG_CODE to further verify if the destination for storing the boot animation, for example, the storage device 125, has a memory capacity not less than a size of the boot animation update file stored on the optical disc 115. It is necessary for the present invention to generate an error message or otherwise abort in the event that the storage device 125 lacks sufficient capacity for storing the intended audio/video boot animation located on the optical disc 115. In describing FIG. 2 and FIG. 3 additional details are provided to further explain the process of generating a boot animation disc, then using the boot animation disc as the optical disc 115 for adding or updating the boot animation to the optical disc player 10.

However, the present invention will not simply store boot animation after recognizing boot animation update disc. Having only a single boot animation for an optical disc player is the only situation that makes sense. Recall, the boot animation is intended for playing (i.e., viewing and listening if sound is included) during the short time between power on of the optical disc player 10 and the time when the menu associated with, for example, a DVD disc containing a movie, is presented to the user via the output device 105. Therefore, if the present invention determines that the optical disc 115 is not a regular disc, for example, DVD media, but rather a disc intended for adding or updating a boot animation to the optical disc player, the present invention will overwrite an existing audio and video data stream stored in the storage device 125 with the specific video stream and the specific audio stream stored found on the optical disc 115.

Finally, coupled to the driving circuit 110 is the output device 105. The output device 105 further comprises a speaker unit 130 and a display unit 135. The display unit 135 can be a TV set, an LCD panel, or any other similar display component capable of displaying said video stream. Similarly, the speaker unit 130 simply needs to be capable of presenting said audio stream. The output device's speaker unit 130 receives an audio signal generated from the audio DAC 146 while the output device's display unit 135, if it supports digital input, receives a video signal from the A/V decoder 140. However, if the display unit 135 supports analog input only, then a video DAC (not shown) is needed.

It should be noted that the output device 105 shown in FIG. 1 is embedded in the optical disc player 10. For instance, the optical disc player 10 is a portable media player capable of providing the user with personal audio/video entertainment. However, the output device 105, in another embodiment, is excluded from the optical disc player 10 and becomes an external device coupled to the optical disc player 10. These alternative designs fall in the scope of the present invention.

Please note that the present invention operates in three modes. In the first mode, a boot animation is played that has been previously added to the optical disc player 10. In the second mode, a pre-generated and correctly configured (i.e., formatted) optical disc 115 is inserted into the optical disc player 10 and thereafter the present invention proceeds to add (or in the case that boot animation exists, to update) the boot animation of the optical disc player 10. In the third mode, the optical disc player 10 is utilized for generating the specified boot animation stream format. We can extract a clip of media stream during playback as specified boot animation stream format and adding or updating it into storage device 115.

To further explain the present invention optical disc player 10, please refer to FIG. 2. FIG. 2 is a flow chart showing a method for a boot sequence of an optical disc player according to an embodiment of the present invention.

Step 200: Start.

Step 210: Run boot loader.

Step 220: Display a first video frame.

Step 230: Play boot animation.

Step 240: Continue disc player boot sequence.

Step 250: Stop.

In step 200, the optical disc player 10 is turned on. In step 210, the boot loader (i.e., BOOT_LOADER shown in FIG. 1) is executed whereby the present invention is able to read a boot animation data stream stored in the optical disc player 10, for example, in the storage device 125, and processing the boot animation data stream DATA for displaying the boot animation, for example, with the processor 120. However, to minimize any perceptible delay to the user in the initiation of the boot animation, a first frame of the boot animation data stream DATA, such as an I-frame, is read and processed as the first frame for displaying a corresponding image. In step 220, the first frame is displayed to the output device 105. Please note that the step of reading and processing the first frame of the boot animation data stream DATA is performed utilizing hardware only. In step 230, the entire remainder of the boot animation is played. In step 240, the boot animation has completed playing, and the optical disc player 10 continues with the regular boot sequence, for example, accessing the inserted disc and displaying said disc's menu. Finally, in step 250, the operation of the present invention terminates since executing the boot sequence is completed.

To further explain the present invention optical disc player 10, please refer to FIG. 3. FIG. 3 is a flow chart showing a method for adding or updating a boot sequence of an optical disc player according to an embodiment of the present invention.

Step 300: Start.

Step 310: Run boot loader.

Step 320: After the boot sequence is finished, is there a special boot animation disc inserted? If yes then continue with the flow. If no, then go to step 350.

Step 330: Verify if the boot animation files exist, if the disc volume name is correct, if the file path is correct, if the file name is correct, and if there is sufficient storage space existing in the storage device. If all of these verify as correct or true then continue with the flow. If not, go to step 350.

Step 340: Update the boot animation.

Step 350: if the boot animation is updated, the system is restarted and the new boot animation will be displayed at the next optical player system startup, if a regular disc is inserted, run the disc recognizing routine and playback the content on the disc.

The flow above describes the method of adding (or updating) the boot animation data stream DATA to the optical disc player 10. Recall, the boot animation associated with the boot animation data stream DATA is that being displayed during the boot-up sequence of the optical disc player 10. In step 300, the flow beings when the optical disc player 10 is turned on. In step 310, the boot loader (i.e., BOOT_LOADER shown in FIG. 1) is executed thereby activating the present invention. (If the previous boot animation exists, the first I-frame of boot animation will be displayed also.) If the previous boot animation exists, the boot animation will be displayed during the boot sequence. In step 320, a verifying step is executed to ensure that the inserted disc is one that is intended for adding or updating boot animation. For example, the program execution code PROG_CODE, loaded by the program execution boot loader code BOOT_LOADER, is executed by the processor 120 to check if the inserted optical disc 115 is intended for adding or updating boot animation. If the optical disc 115 has a specified disc volume then the flow continues. If not, then the flow terminates at step 350. The specified disc volume name can be a predetermined name. This detail is not important to the spirit of the present invention. In step 330, knowing that the inserted optical disc 115 is intended for adding or updating boot animation, additional verifications must be performed by the running program execution code PROG_CODE, such as ensuring the boot animation files are names and located with predetermined (i.e., known) values. If at any time it is determined that the disc is not correctly configured to be a boot animation disc then the process flow is directed to step 350 and terminates thereafter the optical disc player 10 will treat the inserted optical disc 115 as a normal audio/video disc (i.e., a DVD, etc.) and continue with a regular optical disc player boot sequence, the present invention having terminated. Otherwise, continuing to step 340, the optical disc 115 has been verified as being a boot animation disc and the process for adding or updating boot animation to the optical disc player 10 begins. That is, the running program execution code PROG_CODE reads boot animation data from the optical disc 115 and stores the accessed data into the storage device 125; however, if a boot animation data stream has existed in the storage device 125, the boot animation data stream of an older version is replaced (i.e., updated) by the newly read boot animation data stream. The details of this storing operation are all well know to a person of average skill in the pertinent art, therefore, additional details are omitted for the sake of brevity.

Briefly, the process includes receiving a source audio/video data stream from the inserted disc. Next, the update file in the boot animation disc is formatted utilizing the same format used by the storage device 125. As a result, it is possible to add or update the update file in the boot animation disc directly to storage device, for example, in the storage device that can be a Flash memory. Please note that the demultiplexing of the A/V stream can happen when the boot animation disc 115 is generated rather than happening during the process of adding the boot animation. Please note that the boot animation data stream DATA includes the video stream and the audio stream or just the video stream or just the audio stream. In the case where only an audio stream is present, the present invention simply displays a black (i.e., blank) screen or pre-defined static logo screen on the output device 105 during the portion of the boot sequence related to the present invention. In step 350, the operation is complete, and the present invention terminates. At this point, the optical disc player 10 will be restarted automatically. The boot animation has been successfully added to the optical disc player 10 and upon restart; the optical disc player 10 will execute the boot loader, which in turn will display the first frame of the added boot animation data stream according to the present invention. Then the user can immediately see result of adding or updating the boot animation directly after the system restart.

As new video and audio formats are developed, these can easily be utilized without changes to the present invention. The Flash memory as described above can also be used for storing a plurality of flags. For example, a flag can be used for turning on or off the present invention boot sequence. When off, the optical disc player 10 executes its generic boot loader where after no customized boot animation is played. Another flag can be for indicating if the boot animation comprises video, or audio, or both. The video frame rate flag field can set the video frame playback speed to accomplish the synchronization between the audio and video during the boot animation playing. The storage device 125 can be all Flash memory, and an additional, external volatile memory such as DRAM 126 is needed to serve as a buffer for storing codes to be executed. The size of the generic prior art boot loader need only increase by a small amount because only hardware I-frame decoding control code can be added for to this boot code for facilitating the displaying of the first video frame as described earlier. In other words, if the video file is a video format which can be decoded by hardware, then the code segment added to the boot loader need only be enough to execute the decoding of the first I-frame of the video file. Additionally, a small amount of code can be added to the boot loader for moving the present invention's program execution code from non-volatile storage to volatile storage whereby it can be executed for performing the steps of the disclosed method.

Details about the generating of the special boot animation optical disc 115 used for adding or updating boot animation to the optical video player 10 have been omitted. It is obvious to those of average skill in the related art that many methods are available for producing, for example, an optical disc, a DVD or MPEG VCD that has video and audio streams that are located on the disc in predetermined locations and named with predetermined names. The details of these operations are not important to the spirit of the present invention method and device and are therefore omitted herein.

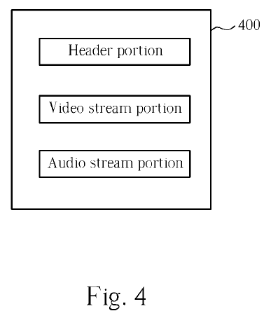

Please refer to FIG. 4. FIG. 4 shows the areas of the boot animation area in an embodiment of the present invention. Specifically, the header portion can, for example, contain a boot animation signature that can detect if the boot animation data is in memory; animation type, video format type, audio format, and many other examples are possible for the format of data portions of the boot animation area. Additionally, the said areas or any other format can be selected, but certain goals like keeping the boot animation file size as small as possible are best kept in mind. For example, by separately storing the video and the audio data, it is possible to reduce the file size of the boot animation because the headers indicating which portion is audio and which portion is video are no longer required. It is also an objective of the format chosen for the boot animation to help keep the processor of the animation device 100 from needing to separate the audio and the video of the boot animation. Rather, the processor 120 of the animation device 100 simply receives said audio and said video streams and performs a decode operation.

Briefly summarized, the present invention offers manufacturers and buyers to customize the optical disc system's boot animation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying a boot animation of an optical disc player during a boot-up sequence of the optical disc player, the method comprising:
reading a boot animation data stream stored in the optical disc player; and
processing the boot animation data stream for displaying the boot animation.

2. The method of claim 1, further comprising:
during an execution of a program execution boot loader code of the optical disc player, reading a first frame of the boot animation data stream and processing the first frame for displaying a corresponding image.

3. The method of claim 2, wherein the step of processing the first frame of the boot animation data stream is performed utilizing hardware only.

4. The method of claim 1, wherein the boot animation data stream has a format type that is: VCD-1, MPEG-2, DIVX, MPEG-4, AC3, DTS, or MP3.

5. A method of adding or updating a boot animation data stream to an optical disc player, a boot animation associated with the boot animation data stream being displayed during a boot-up sequence of the optical disc player, the method comprising:
receiving a source audio/video data stream;
storing the boot animation file in the boot animation update disc into storage device directly when the format of the update disc file and the storage format in the storage device are the same;
wherein the boot animation data stream includes the video stream and the audio stream.

6. The method of claim 5, further comprising:
storing the video stream and the audio stream on an optical disc;
wherein the step of storing the video stream and the audio stream separately comprises:
reading the optical disc to obtain the video stream and the audio stream.

7. The method of claim 6, wherein the step of the step of storing the video stream and the audio stream separately further comprises:
verifying if the optical disc has a specified disc volume, and boot animation update file stored in specified path and having specified file name;
wherein the file are read to be the video stream and the audio stream respectively when the optical disc has the specified disc volume and the boot animation update file stored in the specified path and having the specified file name.

8. The method of claim 6, wherein the step of storing the video stream and the audio stream separately comprises:
verifying if the optical disc has a memory capacity not less than a size of boot animation update file stored on it;
wherein the boot animation update file are read to be the video stream and the audio stream respectively when the optical disc has the memory capacity not less than the size of boot animation update file stored on it.

9. The method of claim 5, wherein if before storing the video stream and the audio stream, a specific video stream and a specific audio stream already exist then overwrite the specific video stream and the specific audio stream with the new video stream and the new audio stream.

10. The method of claim 5, wherein the audio/visual data stream has a format type that is: VCD-1, MPEG-2, DIVX, MPEG-4, AC3, DTS, or MP3.

11. An optical disc player for displaying a boot animation on a display device during a boot-up sequence, the optical disc player comprising:
a processor; and
a storage device, coupled to the processor, for storing a program execution code, the program execution code executed by the processor being utilized for reading a boot animation data stream stored in the storage device and processing the boot animation data stream for controlling the display device to display the boot animation.

12. The optical disc player of claim 11, further comprising:
a program execution boot loader code, the program execution boot loader code executed by the processor being utilized for reading a first frame of the boot animation data stream, wherein the first frame for displaying a corresponding image is processed during an execution of the program execution boot loader code of the optical disc player.

13. The optical disc player of claim 12, wherein the first frame for displaying a corresponding image is processed by hardware only.

14. The optical disc player of claim 11, wherein the boot animation data stream has a format type that is: VCD-1, MPEG-2, DIVX, MPEG-4, AC3, DTS, or MP3.

15. An optical disc player for adding or updating a boot animation data stream to an optical disc player, a boot animation associated with the boot animation data stream being displayed during a boot-up sequence of the optical disc player, the optical disc player comprising:
a processor; and
a storage device, coupled to the processor, for storing a program execution code, the program execution code executed by the processor being utilized for receiving a source audio/video data stream; demultiplexing the audio/video data stream to generate a video stream and an audio stream; and storing the video stream and the audio stream separately in the storage device; wherein the boot animation data stream includes the video stream and the audio stream.

16. The optical disc player of claim 15, wherein the program execution code further stores the video stream and the audio stream on an optical disc separately and reading the optical disc to obtain the video stream and the audio stream.

17. The optical disc player of claim 16, wherein the program execution code further verifies if the optical disc has a specified disc volume, and boot animation update file stored in specified path and having specified file name; wherein the boot animation update file are read to be the video stream and the audio stream respectively when the optical disc has the specified disc volume and the boot animation update file stored in the specified path and having the specified file name.

18. The optical disc player of claim 16, wherein the program execution code further verifies if the storage device has a memory capacity not less than a size of boot animation update file stored on the optical disc; wherein the boot animation update file are read to be the video stream and the audio stream respectively when the optical disc storage device has the memory capacity not less than the size of boot animation update file stored on the optical disc.

19. The optical disc player of claim 15, wherein the program execution code further checks before storing the video stream and the audio stream, if a specific video stream and a specific audio stream already exist and then overwrites the specific video stream and the specific audio stream with the video stream and the audio stream.

20. The optical disc player of claim 15, wherein the audio/visual data stream has a format type that is: VCD-1, MPEG-2, DIVX, MPEG-4, AC3, DTS, or MP3.
